(19) United States
(12) Patent Application Publication
(10) Pub. No.: US 2018/0114040 A1
(43) Pub. Date: Apr. 26, 2018

(54) CARD READER CASE

(71) Applicant: VISUALSHOWER CORP., Gangnam-gu, Seoul (KR)

(72) Inventor: Hong Kwan PARK, Mapo-gu, Seoul (KR)

(21) Appl. No.: 15/579,899

(22) PCT Filed: Jun. 7, 2016
(86) PCT No.: PCT/KR16/05971

§ 371 Date: Dec. 5, 2017

(30) Foreign Application Priority Data
Jun. 5, 2015 (KR) 10-2015-0080033

(51) Int. Cl. G06K 7/01; G06K 7/08; G06K 7/00

(52) U.S. Cl. CPC G06K 7/01; G06K 7/006; G06K 7/082

(57) ABSTRACT

A card reader case including a case main body inside of which a card reader is housed, a card coupling portion which is formed on one side of the case main body so that a card can be coupled thereto so as to allow placement of a card thereon, and a card recognition portion for detecting coupling or separation of a card from the card coupling portion, and extracting and reading card readout information from the card.

### CROSS REFERENCE TO RELATED APPLICATIONS

This application is the National Stage of International Application No. PCT/KR2016/005971, having an International Filing Date of 7 Jun. 2016, which designated the United States of America, and which International Application was published under PCT Article 21 (2) as WO Publication No. 2016/195444 A1, and which claims priority from and the benefit of Korean Application No. 10-2015-0080033, filed on Jun. 5, 2015 the disclosures of which are incorporated herein by reference in their entireties.

### BACKGROUND

### 1. Field

Aspects of the presently disclosed embodiment relate to a card reader case.

### 2. Brief Description of Related Developments

Online game items are tools that exist on games in various ways so as to add pleasure to users enjoying games through the Internet by wire or by wireless.

Such items are traded online and are traded offline in the form of cards, toys, and the like. Various methods of acquiring items traded in the form of cards, toys, and the like on online games are being developed.

Information disclosed in this Background section was already known to the inventors before achieving the inventive concept or is technical information acquired in the process of achieving the inventive concept. Therefore, it may contain information that does not form the prior art that is already known to the public in this country.

### SUMMARY

Aspects of the presently disclosed embodiment provide a card reader case.

A card reader case according to an aspect of the presently disclosed embodiment includes: a case body in which a card reader is accommodated; a card connection part formed at one side of the case body and holding a case such that the card is detachably attached thereto; and a card recognizer detecting that the card is connected to or disconnected from the card connection part, and reading card readout information from the card when the card is connected to the card connection part.

These and/or other aspects, features, and advantages of the presently disclosed embodiment will become apparent from the following drawings, claims, and detailed description of the presently disclosed embodiment.

According to aspects of the presently disclosed embodiment, a card reader case can be provided.

### BRIEF DESCRIPTION OF THE DRAWINGS

FIG. 1 is a block diagram schematically illustrating a game service providing system according to an aspect of the presently disclosed embodiment.

FIG. 2 is a diagram schematically illustrating a card reader 30 of FIG. 1 and a card reader case 40.

FIG. 3 is a block diagram illustrating the internal structure of the card reader case 40 of FIG. 2.

FIG. 4 is a flowchart of a game service providing method according to an aspect of the presently disclosed embodiment.

### DETAILED DESCRIPTION

The advantages and features of the presently disclosed embodiment and methods for achieving the same will become apparent from the following aspects that are described in detail in conjunction with the accompanying drawings. However, it should be understood that these aspects are not construed as limited to the illustrated forms and include all changes, equivalents, or alternatives within the idea and the technical scope of the presently disclosed embodiment. The following aspects are provided so that this disclosure will be thorough and complete, and will fully convey the scope of the disclosed embodiment to those skilled in the art. In the following descriptions, descriptions of well-known functions and constructions will be omitted if they are considered to unnecessarily obscure the gist of the presently disclosed embodiment.

The terminology used herein is for the purpose of describing particular aspects only and is not intended to limit the scope of the presently disclosed embodiment. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof. It will be understood that although the terms “first”, “second”, etc. may be used herein to describe various components, these components should not be limited by these terms. These components are only used to distinguish one component from another.

The terms “communication”, “communication network”, “Internet network”, and “network” used herein may be used as the same meaning. The above terms mean a wired or wireless local and wide area data transmission and reception network that enables files to be transmitted and received between a user terminal, terminals of other users, and a download server.

In the present specification, when one component “transmits” data to another component, it means that the component may transmit the data directly to the other component, or may transmit the data to the other component through at least one other component.

In contrast, when one component “directly transmits” data to another component, it means that the data is transmitted to the other component without passing through another component.

The terms “unit” and “module” used herein may mean a functional and structural combination of hardware for performing the technical spirit of the presently disclosed embodiment and software for driving the hardware. For example, the term “module” may mean a logical unit of predetermined codes and hardware resources for performing the predetermined codes, and it will be apparent to those skilled in the art that the module is not limited to physically connected codes or one type of hardware.

Hereinafter, aspects of the presently disclosed embodiment will be described in detail with reference to the accompanying drawings, and in the drawings, like reference numerals denote like elements, and a redundant explanation thereof will not be provided herein.

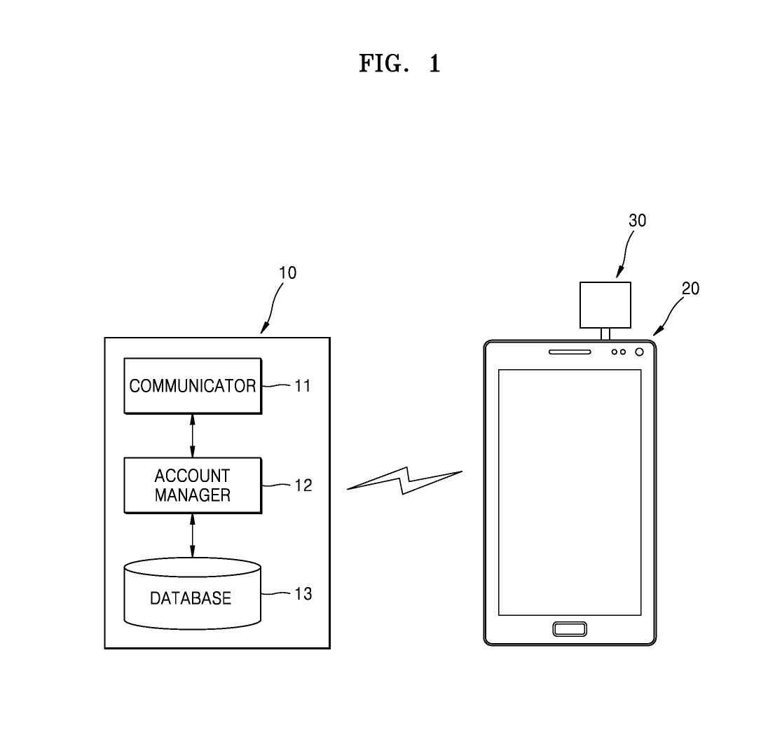

FIG. 1 is a block diagram schematically illustrating a game service providing system according to an aspect of the presently disclosed embodiment.

Referring to FIG. 1, the game service providing system according to the aspect of the presently disclosed embodiment includes a game service providing device 10, a user terminal 20, and a card reader 30.

The user terminal 20 reads information from a card to be read by using a card reader 30 mounted on the user terminal 20, and transmits the read information to the game service providing device 10. The user terminal 20 may communicate with the game service providing device 10 via a communication network. The user terminal 20 executes a game program downloaded from the game service providing device 10 to provide a game to a user while communicating with the game service providing device 10.

The user terminal 20 means an electronic device capable of using a communication service in a wired or wireless communication environment. The user terminal 20 may be a personal computer of the user, or may be a mobile terminal of the user. The user terminal 20 is illustrated in FIG. 1 as being a smart phone, but aspects of the presently disclosed embodiment are not limited thereto. Any electronic devices may be used as the user terminal 20 as long as the electronic device can execute the game program provided by the game service providing device 10 and can use a communication service.

When the card reader 30 is mounted on the user terminal 20, the user terminal 20 may read identification information of the card reader 30 from the card reader 30. The card reader 30 is mounted at a port of the user terminal 20 and is attachable and detachable. For example, the card reader 30 may be mounted at an audio pin of the user terminal 20 and may be supplied with power from the user terminal 20 through the audio pin. The user terminal 20 may transmit identification information to the game service providing device 10, receives level information of the card reader 30 from the game service providing device in response to the transmission of the identification information, and display the level information on a screen.

The game service providing device 10 includes a communicator 11, an account manager 12, and a database 13.

The communicator 11 communicates with the user terminal 20 to transmit and receive packet data. The communicator 11 may receive identification information of the card reader 30 from the user terminal 20 and receive readout information from a card to be read by using the card reader 30.

The identification information of the card reader 30 is unique identification information assigned to each card reader 30 existing in kind, and is information used for specifying the card reader 30. Information about the card reader 30, for example, user account information linked to the card reader 30, level information of the card reader 30, or the like, may be stored in the database 13 in association with the identification information of the card reader 30.

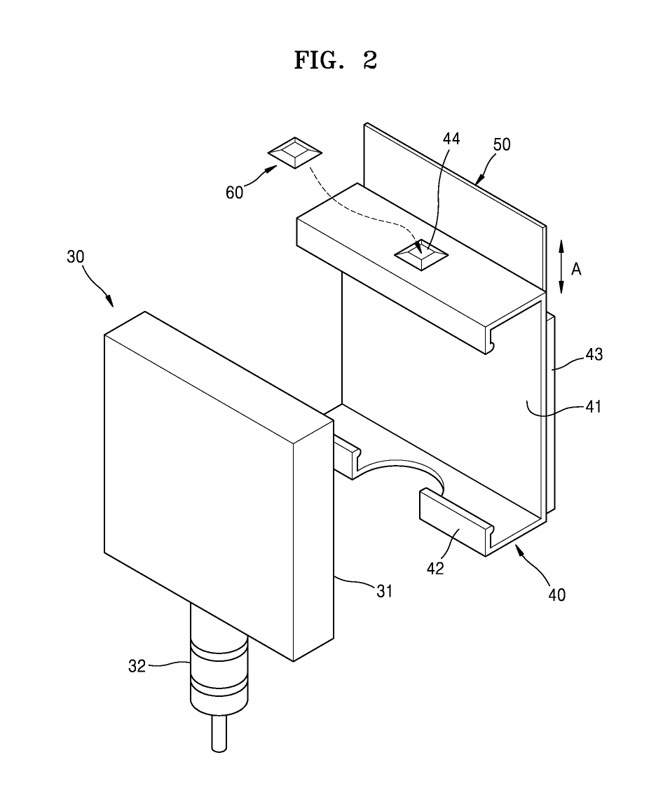

The database 13 may store a card reader account, may include a plurality of fields for the card reader account, and may store a card reader identification number, user account information linked to the card reader, card reader level information, and the like in each field. A level may be assigned to the card reader 30, and the level of the card reader 30 may be changed by a level change source (see 60 of FIG. 2). For example, the level change source (see 60 of FIG. 2) may be a reinforced stone or the like including a function capable of changing the level of the card reader 30.

The user may progress a game by utilizing the card read by using the card reader 30, and the level of the card reader 30 may influence the progress of the game. For example, the level of the card reader 30 may determine performance of an item included in the card, or may determine a level change success rate when a level of a target card is changed by using a source card.

Information read by using the card reader 30 may include payment code readout information of the card or card readout information. However, the presently disclosed embodiment is not limited thereto. The payment code readout information may be transmitted to the game service providing device 10 after the payment code readout information is read by using a separate payment code reader (not illustrated). The payment code reader (not illustrated) may be mounted on the user terminal 20 or a terminal (not illustrated) of a seller.

A card (see 50 of FIG. 2) to be read may include a radio frequency module between outer cases, and a payment code may be displayed on the outer case. The payment code reader (not illustrated) may acquire payment code readout information by reading the payment code displayed on the card outer case. The payment code may be a two-dimensional displayable code, for example, a barcode or a QR code.

The card reader 30 may acquire card readout information from the radio frequency module provided between the outer cases of the card (see 50 of FIG. 2). As the method of acquiring readout information from the card, the card reader 30 may use an RF communication method. Any methods may be employed without limitations as long as readout information mounted on a card having a separate power source can be read by wireless by the card reader 30 supplied with power.

The card readout information may include information about the card itself (see 50 of FIG. 2), for example, card information and/or item information.

The card information may include card identification information identifying the card, card function information identifying the function of the card, and item identification information identifying the item included in the card. However, the card information received from the user terminal 20 may include only card identification information. In this case, the card function information and the item information may be stored in the database 13 in association with the card identification information.

The card (see 50 of FIG. 2) is an actual article including the item that can be utilized in the game. However, the card may not include the item and may include only the function that can be used for the level change of another card. A level may be assigned to each card. In the card including the item (hereinafter, referred to as a “target card”), the performance of the item may be determined according to the level. A worth of a source card utilized for the level change of another card may be changed according to the level. Parameters, such as the number of times the level of another card can be changed, the degree of change of the level of another card, and the like, may be determined according to the level of the source card. The source card may be utilized for not only the level change of the target card and also the level change of the card reader 30. The source card having the function of changing the level of the target card and the source card having the function of changing the level of the card reader 30 may be separately provided, but may be implemented by one source card.

The card function information may include information about the card function, such as whether the card is the target card subjected to the level change, whether the card is a first source card used for changing the level of the target card, or whether the card is a second source card used for changing the level of the card reader 30. The worth of the source card may disappear after the source card is utilized for changing the level of the level change target card or the level of the card reader 30.

The card may be designed to include the function of only one of the target card, the first source card, and the second source card, but the presently disclosed embodiment is not limited thereto. For example, the card may include the functions of two or more of the target card, the first source card, and the second source card. That is, the card may be used as the target card, the first source card, or the second source card according to a user's selection. For example, when the first card is the target card including a specific item and also has the function of the first source card, the user may utilize the first card in the game while continuously raising the level of the first card by using another card having the function of the first source card as long as the item included in the first card is an item helpful for the game. On the other hand, if the item included in the first card is an unnecessary item, the first card may be consumed by using the first card as the source card that changes the level of another card.

The communicator 11 may transmit, to the user terminal 20, at least one of card account generation notification, card level change display information, and reader level change display information. For example, the communicator 11 may transmit the card account generation notification corresponding to payment code readout information to the user terminal 20 that has generated and transmitted the payment code readout information. The communicator 11 may transmit the card level change display information corresponding to the payment code readout information to the user terminal 20 that has generated and transmitted the payment code readout information. The communicator 11 may transmit the level change display information of the card reader 30 corresponding to the reader identification information and the card level change display information corresponding to the card readout information to the user terminal 20 that has transmitted the reader identification information and the card readout information.

The account manager 12 generates a card account corresponding to the card based on payment code readout information received through the communicator 11. For example, the account manager 12 may generate a card account corresponding to one card based on payment code readout information for one card. As another example, the account manager 12 may generate a plurality of card accounts corresponding to a plurality of cards included in a card bundle, based on payment code readout information for one card bundle.

The account manager 12 may generate the card account by generating a field that stores information about the card account in the database 13 to be described below. The field may mean a predetermined data storage designation region in a storage region of the database 13.

The information about the card account may include at least one of card identification information identifying the card, card function information indicating whether the card is the level change target card or the level change source card, card level information indicating a current level of the card, and item identification information identifying the item included in the card.

According to an aspect of the presently disclosed embodiment, the account manager 12 may generate at least one of a user identification information field, a card function information field, a card level information field, and an item identification information field in the database 13.

For example, when the communicator 11 receives first card readout information including first card identification information, the account manager 12 may generate a first card account corresponding to a first card based on the first card readout information. When the first card is the level change target card, the account manager 12 may store first card identification information in the card identification information field, store first card function information indicating that the first card is the level change target card in the card function information field, store first card level information, for example, default information, in the card level information field, or store item identification information of the first card in the item identification information field.

As another example, when the communicator 11 receives second card readout information including second card identification information, the account manager 12 may generate a second card account corresponding to a second card based on the second card readout information. When the second card is the source card for changing the level of the level change target card, the account manager 12 may store second card identification information in the card identification information field, store second card function information indicating that the second card is the level change source card in the card function information field, store second card level information indicating the worth of the second card as the source card for changing the level of the level change target card in the card level information field, or store information indicating the absence of the item in the item identification information field.

The account manager 12 may generate the card account generation notification notifying the generation of the card account, and the communicator 12 may transmit the card account generation notification to the user terminal 20.

The account manager 12 retrieves a card reader account corresponding to the card reader identification information in the database 13 based on card reader identification information received through the communicator 11. When there is no card reader account corresponding to the card reader identification information, a card reader account corresponding to the card reader identification information is generated. The account manager 12 may generate the card reader account by generating a field that stores information about the card reader account in the database 13.

The information about the card reader account may include a card reader identification number, user account information linked to the card reader, and card reader level information.

According to an aspect of the presently disclosed embodiment, the account management unit 12 may generate at least one of a card reader identification number field, a user account information field, and a card reader level information field in the database 13.

For example, when the communicator 11 receives identification information of a first card reader, the communicator 11 may retrieve an account of the first card reader in the database 13 based on the identification information. When there is no account of the first card reader, the account manager 12 may generate a first card reader account corresponding to the first card reader. The account manager 12 may store the first card reader identification information in the card reader identification number field, store the first reader identification information in the user account information field, and store the level information of the first card reader, for example, default information, in the card reader level information field.

The account manager 12 may generate a card reader account generation notification notifying the generation of the card reader account, and the communicator 11 may transmit the card reader account generation notification to the user terminal 20.

Meanwhile, the account manager 12 changes the level of the target card based on the card readout information. The card readout information may be target card readout information and source card readout information. The target card readout information may include at least one of target card identification information, target card classification information, target card level information, and item identification information, and the source card readout information may include source card identification information, source card classification information, and source card level information.

The account manager 12 may change the level of the target card by storing the newly changed target card level information in the card level information field based on the card readout information.

According to an aspect of the presently disclosed embodiment, the account manager 12 may generate new target card level information of the target card based on the target card readout information of the target card and the source card readout information of the source card. The account management unit 12 may specify a reader of which a level is to be changed, based on reader recognition information, and find a current reader level of the specified reader. The account management unit 12 may find the current card level of the target card from the target card readout information, and may find the current card level of the target card from the information stored in the card level information field of the target card account of the specified target card, but the presently disclosed embodiment is not limited thereto. The account manager 12 may acquire the level change source based on the source card readout information, and generate newly changed target card level information by applying the level change source to the current card level of the specified target card. The account manager 12 may store newly changed target card level information in the card level information field of the target card account.

For example, based on the target card readout information including the first target card level information, the account manager 12 may find that the target card of which the level is to be changed is a first reader, and a current card level of the first card is a default level. The account manager 12 may acquire a level-1 change source based on the source card readout information, and generate second target card level information indicating level 1 by applying the level-1 change source to the default level of the first card. The account manager 12 may store second target card level information in the card level information field of the first card account.

According to another aspect of the disclosed embodiment, the account manager 12 may generate new source card level information of the source card based on the target card readout information of the target card and the source card readout information of the source card. The account manager 12 may specify the source card based on the source card readout information and acquire the level change source from the specified source card. The account manager 12 may find the current card level of the source card from the source card readout information, and may find the current card level of the source card from the information stored in the card level information field of the source card account of the specified source card, but the presently disclosed embodiment is not limited thereto. As a result of acquiring the level change source, if the level change source does not remain in the source card any more, the account manager 12 may generate new source card level information indicating no worth as the level change source. The account manager 12 may store new source card level information in the card level information field of the source card account.

For example, based on the source card readout information, the account manager 12 may find that the source card is a second card, and the second card has a worth as a current source, and may acquire a level-1 change source based on the first source card level information. As a result of acquiring the level-1 change source from the second card, if the level change source does not remain in the second card any more, the account manager 12 may generate second source card level information indicating no worth as the level change source. As a result of acquiring the level-1 change source from the second card, if the level change source remains in the second card, the account manager 12 may generate third source card level information indicating a worth as the level change source. The account manager 12 may store second source card level information or third source card level information in the card level information field of the second card account.

When the information stored in the card level information field is changed, the account manager 12 generates card level change display information.

According to an aspect of the disclosed embodiment, when the newly changed target card level information of the target card is stored in the card level information field of the target card account, the account manager 12 may generate new target card level information. For example, when the second target card level information is stored in the card level information field of the account of the first card that is the target card, the account manager 12 may generate information indicating that the card level of the first card has been changed to level 1.

According to another aspect of the disclosed embodiment, when the new source card level information of the source card is stored in the card level information field of the source card account, the account manager 12 may generate new source card level information. For example, when the second source card level information is stored in the card level information field of the account of the second card that is the source card, the account manager 12 may generate information indicating that the second cannot be utilized as the source card any more. As another example, when third source card level information is stored in the card level information field of the account of the second card that is the source card, the account manager 12 may generate information indicating how many times the second card can be utilized as the source card in the future, but the presently disclosed embodiment is not limited thereto.

The account manager 12 may change the level of the target card by multiple levels based on target card readout information of the target card and a plurality of pieces of source card readout information of a plurality of source cards.

The database 13 stores information about the card account. The database 13 may store and change information about at least one card account under the control of the account manager 12.

According to aspects of the presently disclosed embodiment, the source card that is a type of dummy card is utilized to change the card level of the target card, thereby improving the utility of the game card.

Meanwhile, the account manager 12 changes the level of the card reader based on reader recognition information and level change source recognition information.

According to an aspect of the disclosed embodiment, the account manager 12 may change the level of the card reader 30 by storing newly changed reader level information in a reader level information field based on the reader recognition information and the level change source recognition information.

That is, the account manager 12 may generate new reader level information of the card reader 30 based on the reader recognition information and the level change source recognition information. The account manager 12 may specify a card reader 30 of which a level is to be changed, based on reader recognition information, and find a current reader level of the specified card reader. The account manager 12 may find the current reader level of the card reader 30 from the reader recognition information, and may find the current reader level of the card reader 30 from information stored in the card reader level information field of the card reader account corresponding to the specified card reader 30, but the presently disclosed embodiment is not limited thereto. The account manager 12 may specify a level change source based on the level change source recognition information, and generate newly changed reader level information by applying the specified level change source to the current reader level of the specified card reader 30. At this time, the account manager 12 may specify the level change source by extracting the type and the number of level change sources from the level change source recognition information. Then, the account manager 12 may store newly changed reader level information in the reader level information field of the reader account.

For example, based on the reader recognition information, the account manager 12 may find that the card reader 30 of which the level is to be changed is a first reader, and a current reader level of the first reader is a default level. The account manager 12 may acquire one level-1 change source based on the level change source recognition information, and generate second reader level information indicating level 1 by applying the level-1 change source to the default level of the first reader. Alternatively, the account manager 12 may acquire a plurality of level-1 change sources, for example, four level-1 change sources, based on the level change source recognition information, and generate second reader level information indicating level 4 by applying the level-4 change source to the default level of the first reader. The account manager 12 may store second reader level information in a reader level information field of a first reader account.

The account manager 12 may generate reader level change display information after storing the second reader level information in the reader level information field.

The database 13 stores information about the card reader 30. The information about the card reader 30 may include at least one of reader identification information identifying the card reader 30 and reader level information indicating the current level of the card reader 30.

According to aspects of the presently disclosed embodiment, the level change source (see 60 of FIG. 2) is utilized to change the level of the target card reader 30, thereby improving the utility of the card reader itself.

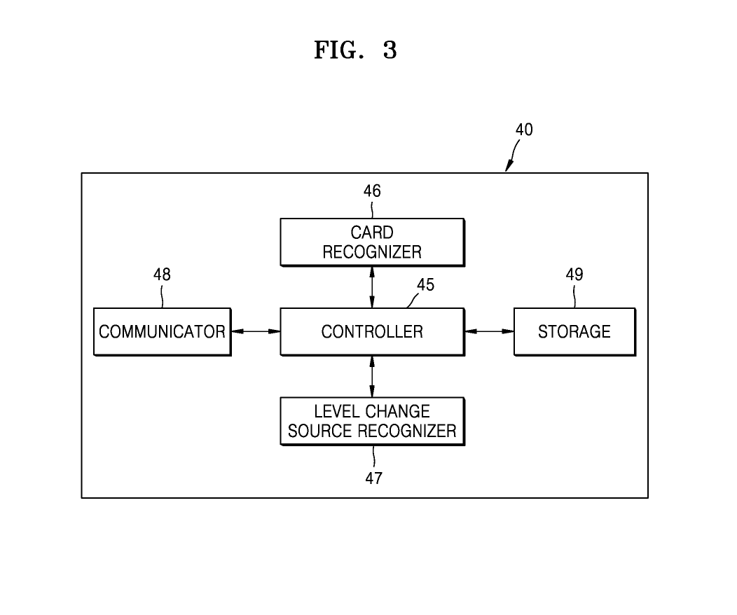

FIG. 2 is a diagram schematically illustrating the card reader 30 of FIG. 1 and a card reader case 40, and FIG. 3 is a block diagram illustrating the internal structure of the card reader case 40.

Referring to FIG. 2, the card reader 30 may include a main body 31 and a connector 32.

The main body 31 includes a reading module capable of reading card information, and a storing module capable of storing identification information of the card reader 30. The reading module may read card readout information from the card in a contact or non-contact manner, and the card readout information read from the card may be transmitted to the user terminal 20 through the connector 32. The reading module may read the card information in an RF method, but is not limited thereto. Identification information of the card reader 30 may also be transmitted to the user terminal 20 through the connector 32.

The connector 32 is mounted on the main body 31 and transmits and receive information through a connection port of the user terminal 20. The connection port may include a microphone connection terminal, an earphone connection terminal, and the like. The connector 32 may have a size appropriate for the size of the connection port of the user terminal 20.

Referring to FIGS. 2 and 3, the card reader case 40 may include a case body 41, a reader fixing part 42 fixing the card reader 30 when connected to the card reader 30, a card connection part 43 formed at one side of the case body 41 and holding the card 50 such that the card 50 is detachably attached thereto, and a level change source connection part 44 formed at one side of the case body 41 and holding a level change source 60 such that the level change source 60 is detachably attached thereto. Also, the card reader case 40 further includes a controller 45, a card recognizer 46, a level change source recognizer 47, a communicator 48, and a storage 49.

The case body 41 defines a base of the card reader case 40 and is formed such that the card reader 30 can be accommodated therein. The case body 41 may have various shapes so as to be connectable according to the shape and characteristics of the card reader 30.

The reader fixing part 42 serves to fix the card reader 30 when the card reader case 40 is connected to the card reader 30. For example, the reader fixing part 42 may protrude from both ends of the case body 41 of the card reader case 40 to some degree. When the card reader 30 is fitted into the card reader case 40, the case body 41 elastically deforms to some degree and the card reader 30 is fitted into the card reader case 40. Once the card reader 30 is fitted into the card reader case 40, the connection state may be maintained by the protruding reader fixing part 42. To this end, the case body 41 may be made of a material such as a synthetic resin that can elastically deform to some degree. However, the presently disclosed embodiment is not limited thereto. Any structures, such as a magnetic member or an adhesive member, can be utilized as the reader fixing part 42 as long as the card reader 30 can be fixed to the card reader case 40.

The card fixing part 43 may be formed at one side of the case body 41 and may serve to hold the card 50 such that the card 50 is detachably attached thereto. That is, the card 50 is detachably attached to the card connection part 43 in a direction of an arrow A.

The level change source connection part 44 may be formed at one side of the case body 41 and may serve to hold the level change source 60 such that the level change source 60 is detachably attached thereto. In the drawing, the level change source connection part 44 is formed as a recess having a shape corresponding to the level change source 60, and the level change source 60 is engaged with the level change source connection part 44, but the presently disclosed embodiment is not limited thereto. Various methods are possible. For example, a jack is formed at one side of the level change source connection part 44 or the level change source 60, and a port is formed at the other side, such that one side is mutually connected to the other side.

Furthermore, the card reader case 40 further includes a controller 45, a card recognizer 46, a level change source recognizer 47, a communicator 48, and a storage 49.

The card recognizer 46 may serve to detect that the card 50 is connected to or disconnected from the card connection part 43 under the control of the controller 45. Furthermore, when the card 50 is connected to the card connection part 43, the card recognizer 46 may read card readout information from the card 50. In this case, the card readout information may include information about the card 50 itself, for example, card information and/or item information.

The target card may be connected to the card connection part 43 of the card reader case 40, and the source card that is read by the card reader 30 while the target card is connected to the card connection part 43 may be used for the level change of the target card held in the card reader case 40.

That is, while the number of “target cards” that is cards including the item is small, the number of “source cards” used for the level change of another card may be large. Also, while the target card is a card continuously owned by a user, the source card is often discarded after used once. In this case, it may be preferable not to confuse the target card with the source card by changing the storing and using method itself. To this end, in the presently disclosed embodiment, the card connection part 43 capable of holding the card 50 may be provided, and the target card that is continuously owned by the user may be held in the card connection part 43. After one or more source cards are read by the card reader 30 and used for the level change of the target card held in the card reader case 40, the source cards may be immediately discarded. The card reader case 40 capable of separately holding the target card having high worth is provided to further improve the usability and utility of the card reader case 40 and also improve the user convenience.

The level change source recognizer 47 may serve to detect that the level change source 60 is connected to or disconnected from the level change source connection part 44 under the control of the controller 45. Furthermore, when the level change source 60 is connected to the level change source connection part 44, the level change source recognizer 47 may read level change source recognition information from the level change source 60. The read level change source recognition information may be transmitted to the card reader 30 through the communicator 48 and used for the level change of the card reader 30.

Specifically, the level change source 60 may include a function of changing the level of the card reader 30. In order to directly connect the level change source 60 to the card reader 30, the structure of the card reader 30 needs to be modified, which causes a problem that a consumer has to purchase a new card reader 30. In order to solve such a problem, a card reader case 40 capable of connecting the level change source 60 is provided such that the level change source 60 is connected to the card reader 30 to enable the level change of the card reader 30 even if the structure of the card reader 30 itself is not modified, thereby obtaining the effect of broadening the versatility of the card reader 30.

The communicator 48 provides a communication interface required to transmit and receive card readout information read by the card recognizer 46 or level change source recognition information read by the level change source recognizer 47 to and from the card reader 30 under the control of the controller 45. The communicator 48 may be a device including hardware and software required for transmitting and receiving signals, such as control signals or data signals, via wired or wireless connection to other network devices such as the card reader 30. For example, the communicator 48 may include a short-range wireless communicator. The short-range wireless communicator may be a Bluetooth communicator, a Bluetooth low energy (BLE) communicator, a near field communicator, a wireless local access network (WLAN) (Wi-Fi) communicator, a Zigbee communicator, an infrared data association (IrDA) communicator, a Wi-Fi direction (WFD) communicator, an ultra wideband (UWB) communicator, or an Ant+communicator, but is not limited thereto. Also, although not illustrated, the communicator 48 may be formed in the form of a connection pin or a jack and a port and directly connect the card reader 30 to the card reader case 40.

The storage 49 may serve to store card readout information read by the card recognizer 46 or level change source recognition information read by the level change source recognizer 47 under the control of the controller 45.

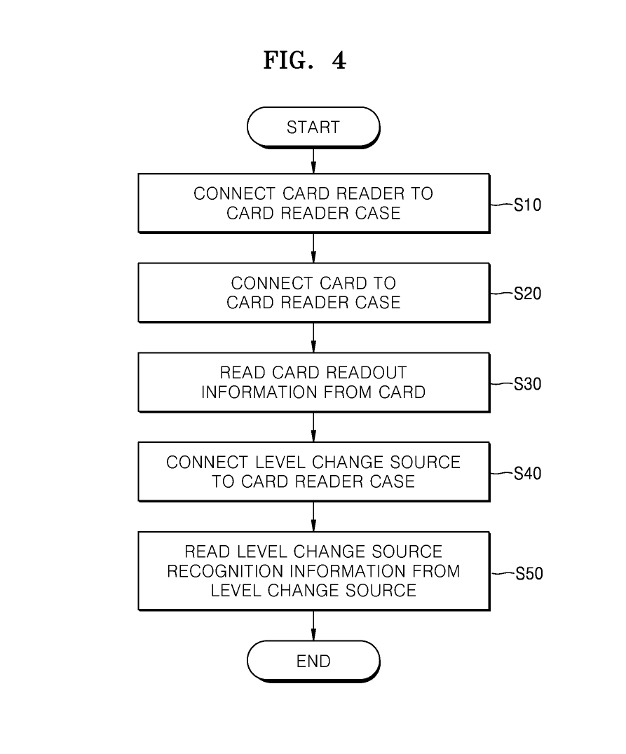

FIG. 4 is a flowchart of a game service providing method according to an aspect of the presently disclosed embodiment.

Referring to FIG. 4, the game service providing method according to the aspect of the presently disclosed embodiment includes: connecting the card reader 30 to the card reader case 40 (S10), connecting the card 50 to the card reader case 40 (S20), and detecting the connection of the card 50 to the card reader case 40 and reading card readout information from the card 50.

In this case, in the connecting of the card 50 to the card reader case 40, the target card may be connected to the card reader case 40. After the reading of the card readout information from the card 50, the source card read by the card reader 30 while the target card is connected to the card reader case 40 may be used for changing the level of the target card. That is, in the presently disclosed embodiment, the card connection part 43 capable of holding the card 50 may be provided, and the target card that is continuously owned by the user may be held in the card connection part 43. After one or more source cards are read by the card reader 30 and used for the level change of the target card held in the card reader case 40, the source cards may be immediately discarded. The card reader case 40 capable of separately holding the target card having high worth is provided to further improve the usability and utility of the card reader case 40 and also improve the user convenience.

Meanwhile, the game service providing method according to the aspect of the presently disclosed embodiment may further include: connecting the level change source 60 to the card reader case 40 (S40); and detecting the connection of the level change source 60 to the card reader case 40 and reading level change source recognition information from the level change source 60 (S50). Furthermore, the game service providing method may further include changing the level of the card reader 30 by using the level change source recognition information read from the level change source 60.

That is, the card reader case 40 capable of connecting the level change source 60 is provided such that the level change source 60 is connected to the card reader 30 to enable the level change of the card reader 30 even if the structure of the card reader 30 itself is not modified, thereby obtaining the effect of broadening the versatility of the card reader 30.

Although the presently disclosed embodiment has been described for illustrative purposes, it will be understood by those of ordinary skill in the art that various modifications and changes can be made thereto without departing from the scope and spirit of the presently disclosed embodiment. Therefore, the technical scope of protection of the presently disclosed embodiment should be determined by the appended claims.

What is claimed is:

1. A card reader case comprising:
a case body in which a card reader is accommodated;
a card connection part formed at one side of the case body and holding a case such that the card is detachably attached thereto; and
a card recognizer detecting that the card is connected to or disconnected from the card connection part, and reading card readout information from the card when the card is connected to the card connection part,
wherein a target card is connected to the card connection part, and a source card read by the card reader while the target card is connected to the card connection part is used for changing a level of the target card.

2. The card reader case of claim 1, further comprising:
a level change source connection part formed at one side of the case body and holding a level change source such that the level change source is detachably attached thereto; and
a level change source recognizer detecting that the level change source is connected to or disconnected from the level change source connection part, and reading level change source recognition information from the level change source when the level change source is connected to the level change source connection part.

3. The card reader case of claim 2, wherein, when the level change source is connected to the level change source connection part, the level change source recognition information is read from the level change source, and a level of the card reader is changed by using the level change source recognition information.

4. A game service providing method comprising:
connecting a card reader to a card reader case;
connecting a card to the card reader case; and
detecting that the card is connected to the card reader case, and reading card readout information from the card,
wherein, in the connecting of the card to the card reader case, a target card is connected to the card reader case, and
after the reading of the card readout information from the card, a source card read by the card reader while the target card is connected to the card reader case is used for changing a level of the target card.

5. The game service providing method of claim 4, further comprising:
connecting a level change source to the card reader case; and
detecting that the level change source is connected to the card reader case, and reading level change source recognition information from the level change source.

6. The game service providing method of claim 5, further comprising changing a level of the card reader by using the level change source recognition information read from the level change source.
